(19) United States
(12) Patent Application Publication
(10) Pub. No.: US 2002/0170067 A1
(43) Pub. Date: Nov. 14, 2002

(54) Method and apparatus for broadcasting streaming video

(76) Inventors: Anders Norstrom, Sodertalje (SE); Kay Johansson, Vallentuna (SE); Kent Karlsson, Jarfalla (SE); Emil Petersson, Jarfalla (SE); Thomas Kjell, Ronninge (SE)

Correspondence Address: JENKENS & GILCHRIST, 3200 Fountain Place, 1445 Ross Avenue, Dallas, TX, 75202-2799, US

(21) Appl. No.: 10/105,526

(22) Filed: Mar. 25, 2002

Related U.S. Application Data
(60) Provisional application No. 60/278,193, filed on Mar. 23, 2001.

(51) Int. Cl. H04N 7/173

(52) U.S. Cl. 725/109; 725/87

(57) ABSTRACT

Method and apparatus for broadcasting streaming video. A method for broadcasting streaming video according to the present invention has the steps of receiving a plurality of video input streams, each of the plurality of video input streams being transmitted via an IP-based network, selecting one of the plurality of video input streams for broadcast as a video output stream, and broadcasting the video output stream. The invention provides a technique by which any of a plurality of video input streams transmitted via the Internet or other IP-based network can be selectively broadcast in real time, and in which switching among the plurality of video input streams can be conducted in real time. The video output stream can also be broadcast over the Internet or other IP-based network such that a viewer can receive the various broadcasts on a PC or other device without re-connecting for each broadcast.

This application claims priority from and the benefit of copending U.S. Provisional Patent Application Serial No. 60/278,193 filed on Mar. 23, 2001.

### BACKGROUND OF THE INVENTION

1. Field of the Invention

The present invention relates generally to a method and apparatus for broadcasting streaming video. More particularly, the present invention relates to a method and apparatus for receiving a plurality of video input streams transmitted over the Internet or other IP-based network, and for selectively switching among the plurality of video input streams for selectively broadcasting the plurality of video input streams as single video output streams.

2. Description of the Prior Art

FIG. 1 is a block diagram that schematically illustrates a television production system that is known in the art. The system is generally designated by reference number 10, and includes a vision mixer (or mixer board) 12 for processing video signals input thereto. Video input signals can include signals from live sources (i.e., television cameras) or from earlier recorded archived materials. For example, as shown in FIG. 1, live sources can include an in-house live source 14 or a live source at a remote location 16. Archived materials can include materials stored on tape 18 and materials stored in digital form in an appropriate file 20. A video output signal from the vision mixer is typically to a traditional TV broadcast network 22; or, as shown in FIG. 1, the output signal may be transmitted to a master tape 24 for storage and retrieval at a later time.

In a traditional television production system, the plurality of video input signals from the various signal sources are transmitted to the vision mixer by cabling, satellite or another connection via an interface on the vision mixer. The vision mixer functions as a switch and is controllable to selectively output any one of the plurality of input signals. For example, a director of a television program or another operator can select a particular one of the plurality of input signals to be shown to a viewer, and operate the vision mixer to output that selected input signal to a TV network for broadcast to the viewer.

A conventional television production system, such as illustrated in FIG. 1, is limited in its capabilities. For example, the video input signals are typically from live sources via cabling or satellite, or from archived sources. The video output signal is typically to a traditional TV network or the like for broadcast to a viewer. Although some capabilities exist for broadcast over other channels, for example, webcast, using formats such as Quicktime, Real or Windows media, the ability to accomplish such broadcasts require several computers and video output cards and is very costly. Broadcast to channels such as the Internet, the Mobile Internet and to various hand-held devices cannot be easily accomplished, if at all. Current vision mixers are unable to support or control the different flows, and a director would have to work with a variety of different output formats to be able to broadcast to every channel. This would put a great deal of strain on both the director and the system architecture, and every production would be costly and require significant man-hours to create.

In general, current TV broadcast technology does not allow video signals to be easily transmitted or received over the Internet. Current vision mixers are not based on any standards and have no input interface for the Internet.

Significant limitations also exist with respect to the broadcast of video streams over the Internet. For example, in a traditional television production, a viewer can watch a single TV channel and receive different broadcasts on that channel as may be determined, for example, by the director of a particular program via operation of a vision mixer. When video streams are transmitted over the Internet, however, it is necessary to open a new stream for every broadcast. With the Internet, accordingly, a viewer must reconnect every time there is a new broadcast. Such a limitation significantly restricts effective utilization of the Internet as a broadcast medium.

There is, accordingly, a need for a technique for broadcasting streaming video that permits selective broadcasting, in any desired format, of any one of a plurality of video input streams transmitted via the Internet or other IP-based network.

### SUMMARY OF THE INVENTION

The present invention provides a method and apparatus for broadcasting streaming video that permits selective broadcasting of any one of a plurality of video input streams transmitted via the Internet or other IP-based network. The selected video stream can be broadcast in any desired format including via the Internet or other IP-based network.

A method for broadcasting streaming video according to the present invention comprises the steps of receiving a plurality of video input streams, each of the plurality of video input streams being transmitted via an IP-based network, selecting one of the plurality of video input streams for broadcast as a video output stream, and broadcasting the video output stream.

The present invention provides a technique by which any one of a plurality of video input streams transmitted via the Internet or another IP-based network can be selectively broadcast in real time. The video input streams can be live streams transmitted from remote locations or archived materials. By using the Internet or other IP-based network as a carrier of the plurality of video input streams, lower costs and a reduction in set-up time can be achieved than when using satellite up-links or the like to transmit the streams.

According to a presently preferred embodiment of the present invention, the selecting step comprises selectively switching among the plurality of video input streams in real time to selectively change the video output stream in real time; and the step of broadcasting the video output stream comprises broadcasting the video output stream via the Internet or another IP-based network. This embodiment permits selective switching of video streams broadcast over the Internet (i.e., going back and forth among the plurality of video input streams), such that a viewer can receive broadcasts of the various video input streams without re-connecting for each broadcast in the same manner that a television viewer can watch different video streams on the same TV channel. The video streams being switched can be video streams having different content, or video streams having the same content but prepared for different bit rates.

According to a further embodiment of the invention, a controller for broadcasting streaming video comprises a receiver for receiving a plurality of video input streams transmitted thereto via an IP-based network, a selector for selecting one of the plurality of video input streams to be broadcast, a switch for switching among the plurality of video input streams for providing the selected video input stream as a video output stream, and a broadcaster for broadcasting the video output stream.

According to embodiments of the invention, in addition to receiving video input streams via the Internet, the receiver can also receive video input streams transmitted via cabling, satellite or in another manner. The video input streams can be live, pre-recorded or buffered streams. The broadcaster can broadcast the video output stream in any type of format via any type of media, including fixed or wireless, or analog or digital-based. The broadcast can also be to any desired apparatus including a PC, a digital or analog TV, a mobile phone or another hand-held device.

According to a further embodiment of the invention, the controller is utilized as a pre-vision mixer in a traditional television production system. In particular, video input streams that come in over the Internet or from a disk storage can be pre-mixed prior to being sent to the vision mixer as a single feed. On the output side of the vision mixer, a controller can take the output feed and transcode it to all the different formats for broadcast to different types of apparatus.

Yet further advantages and specific features of the present invention will become apparent hereinafter in conjunction with the following detailed description of presently preferred embodiments of the invention.

### BRIEF DESCRIPTION OF THE DRAWINGS

FIG. 1 is a block diagram that schematically illustrates a television production system that is known in the art;

FIG. 2 is a block diagram that schematically illustrates a video production system according to a presently preferred embodiment of the present invention;

FIG. 3 is a block diagram that schematically illustrates the master controller of the video production system of FIG. 2 according to another embodiment of the present invention;

FIG. 4 schematically illustrates a digital video stream to assist in explaining an aspect of the present invention;

FIG. 5 schematically illustrates the manner in which an inter frame of a digital video stream is created to assist in explaining an aspect of the present invention;

FIGS. 6 and 7 are diagrams to assist in explaining the operation of the stream tool server of the master controller according to an embodiment of the present invention;

FIG. 8 is a diagram that illustrates a procedure for synchronizing two digital video streams to permit switching between the streams according to another embodiment of the present invention; and

FIG. 9 is a flow chart that illustrates steps of a method for switching among a plurality of video input streams and for selectively broadcasting one of the plurality of video input streams as a single video output stream according to another embodiment of the present invention.

### DETAILED DESCRIPTION OF PRESENTLY PREFERRED EMBODIMENTS OF THE INVENTION

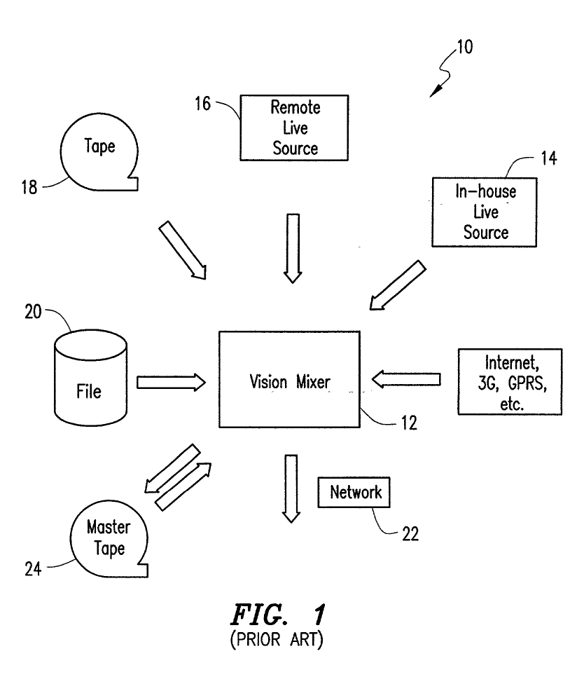

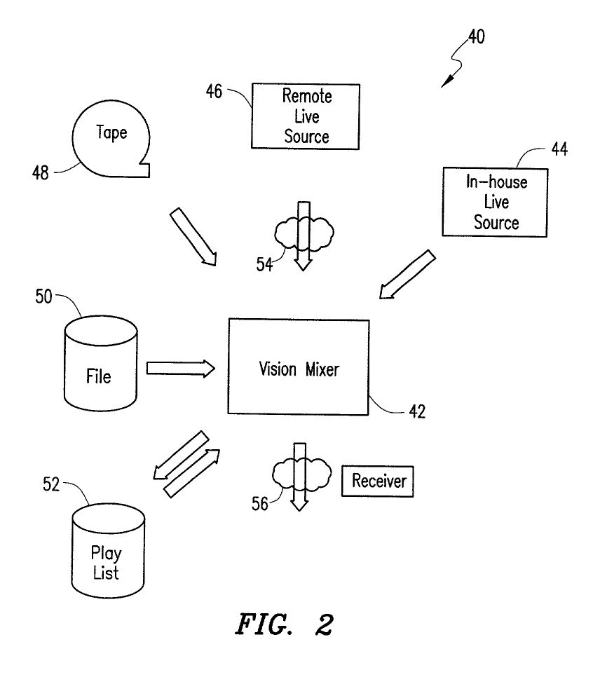

FIG. 2 is a block diagram that schematically illustrates a video production system according to a presently preferred embodiment of the present invention. The system is generally designated by reference number 40, and includes a master controller 42 that generally corresponds to the vision mixer utilized in a traditional television production system such as illustrated in FIG. 1. Master controller 42 receives video input streams from various sources such as a live in-house source 44, a remote live source 46, or from various archived materials such as a tape 48, a file 50 or a play list 52.

The video production system of FIG. 2 differs from system 10 of FIG. 1, however, in that the video streams input to the master controller 42 include video streams transmitted via the Internet or another IP-based network (generally referred to hereinafter as the Internet) as shown at 54, and the video stream output from the master controller 42 includes a video output stream broadcast via the Internet as shown at 56.

The master controller 42 of the present invention permits the Internet to be used as a carrier of both the video input streams and the video output stream. Furthermore, the master controller permits selective switching among the plurality of video input streams in real time. Accordingly, when the video output stream is broadcast over the Internet, a viewer can remain connected to the same IP-address at all times, and receive different video output streams without re-connecting for each broadcast.

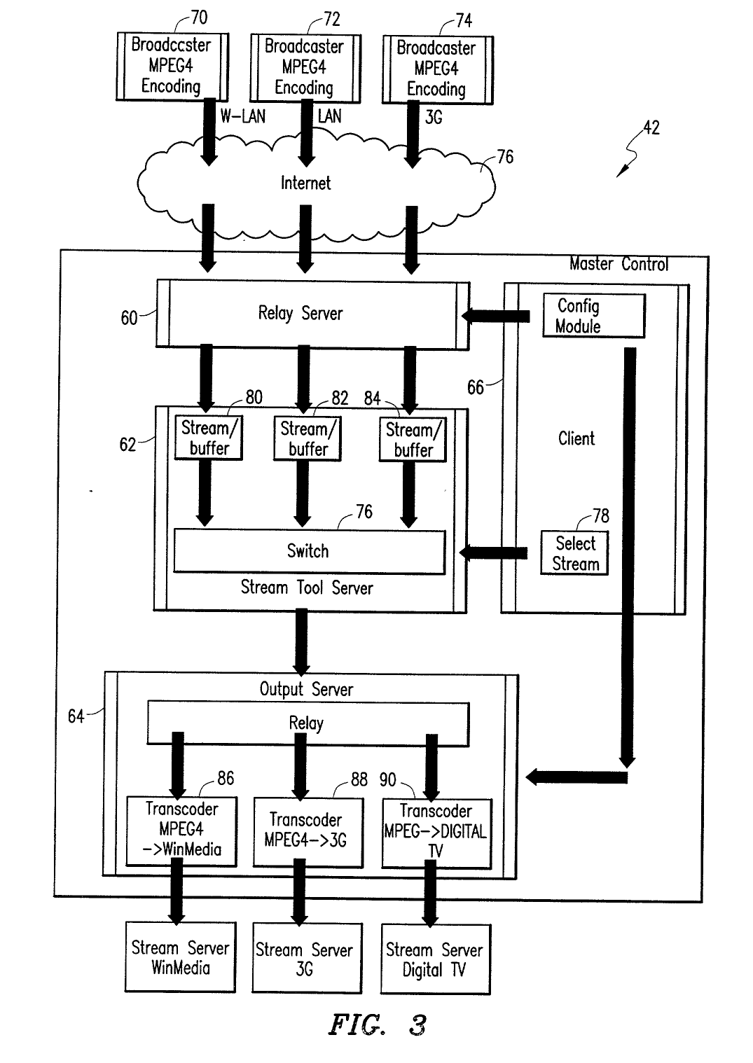

FIG. 3 is a block diagram that schematically illustrates details of the master controller 42 of FIG. 2 according to a presently preferred embodiment of the present invention. The master controller 42 generally comprises a relay server 60, a stream tool server 62, an output server 64 and a client 66. The relay server 60 functions as the input to the master controller 42 and is adapted to receive video input streams from a plurality of video sources, schematically illustrated as sources 70, 72 and 74; and to direct the streams to the stream tool server 62. In particular, video streams from video sources 70, 72 and 74 comprise digital data streams that are transmitted to the master controller via the Internet as schematically illustrated at 76. Although three video sources are shown in FIG. 3, this is intended to be exemplary only as video streams from any desired number of video sources may be received by the master controller 42. In addition, it should also be recognized that although FIG. 3 illustrates video sources that transmit video streams to the master controller via the Internet, the master controller can also receive video streams from other sources via cabling, satellite or other connection.

Stream tool server 62 receives the video input streams from the relay server 60 and includes a switch 76 to permit any one of the plurality of video input streams to be selected for broadcast. Switch 76 is controlled by an operator of the master controller via a stream selector 78 in the client 66. As will be described in detail hereinafter, switch 76 is operable to switch among different video input streams in real time so that any desired one of the plurality of input streams can be broadcast at any time.

In order to be able to switch from a first digital video input stream to a second digital video input stream, the switching must be done on a “key frame” of the second video stream inasmuch as only a key frame of a video stream contains all the data of an image. When working on a live broadcast, in particular, a director or other operator of the master controller 42 often cannot wait until a key frame occurs to effect the switch; and it is important to have the capability of effecting a switch whenever desired. In accordance with an embodiment of the present invention, a key frame is provided that is available “on demand” (i.e., the key frame is super-imposed on other frames) so that a switch between video input signals can be carried out at any time. The manner in which the master controller 42 of the present invention achieves video stream switching and the key frame handling associated with such switching will now be described.

An analog video is made up of a series of non-compressed images that follow each other in order to create a frame with moving content. Adjacent pictures in the analog signal do not depend on each other, but are capable of being viewed as independent pictures. When a TV program is watched, the TV set will receive 30 frames per second (NTSC) or 25 frames per second (PAL).

A digital format of a video/TV signal can be created using a “codec” (short for “encoding and decoding”). When an analog video signal is sent through a codec, the signal is encoded (transformed) into a digital format.

In a digital video signal, every frame is about 2.5 Mb in size which means about 70 Mbits per second. Accordingly, a codec is designed to also compress the signal as much as possible to enable video streaming at lower bit rates. The quality of the digital signal depends on what codec is used. MPEG-2, for example, which is used for DVDs, is a “lossless” codec. It removes as much information as possible but not so much that the resultant image suffers any loss in quality. To maintain the quality of the signal, however, necessitates that a high bit rate be maintained. H.263 is a “destructive” codec in that it reduces the quality of the resultant image to achieve a lower bit rate. This codec is suitable for low bandwidth applications such as video conferencing, for example.

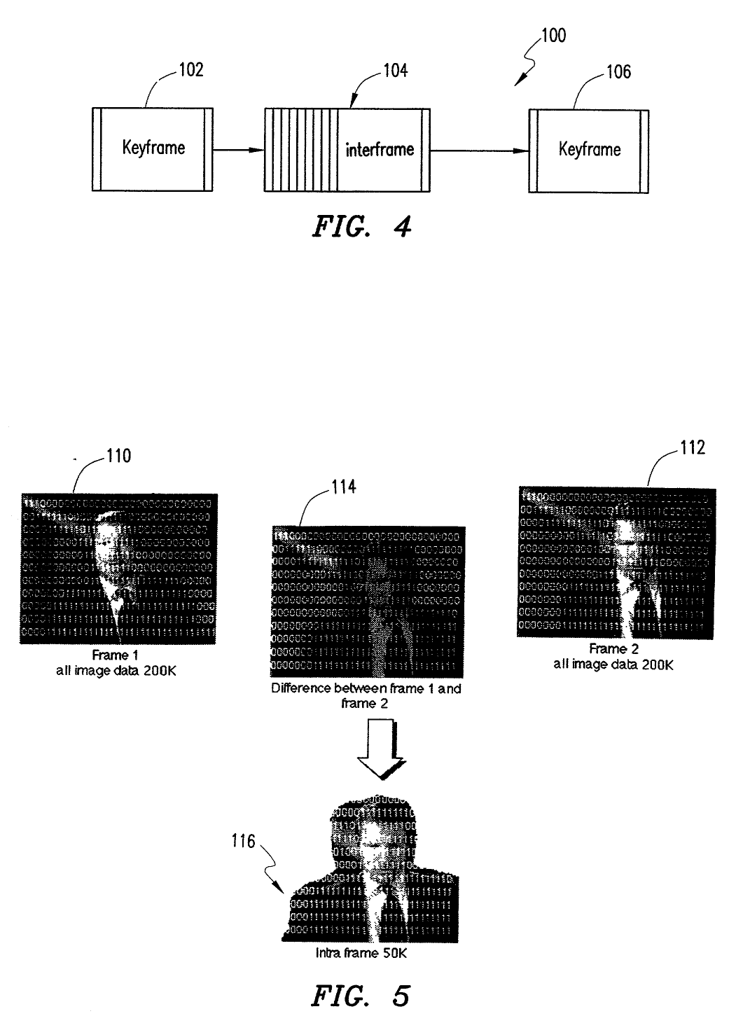

In general, all codecs lower the bit rate in a similar manner. They all use what is referred to as “key frames” and “inter frames”. Specifically, to lower the bit rate, a codec begins by sending a key frame that contains all image data, and then sending inter frames. The inter frames contains only the changes in the image data contained in the key frame. Thus, a digital video stream starts with a key frame, and then contains only inter frames until the next key frame is sent. FIG. 4 schematically illustrates a digital video stream 100 containing key frames and inter frames to assist in explaining the present invention. As shown, a first key frame 102 contains all the data for a particular image. Thereafter, the stream comprises a plurality of inter frames 104, each of which contain data reflecting changes made in the image since the key frame. When the image has changed by a certain amount, another key frame 106 is provided to contain all the image data of the changed image.

FIG. 5 schematically illustrates the manner in which an inter frame is created to further assist in explaining the present invention. As shown, a frame 110 and a frame 112 each contain all image data of an image (200K bits). The difference between frames 110 and 112 is then determined as shown at 114 to create an inter frame 116 at 50K bits. By sending just the changes from one frame to another, the bit rate needed to transmit the video stream can be significantly reduced. By minimizing the number of key frames in the data stream, the bit rate can be further reduced. There are two principal procedures for deciding how often to provide a key frame in the video stream:

1. A particular interval can be specified (e.g., every 100th frame will be a key frame,

2. Natural key frames can be used (an algorithm calculates the difference from one frame to another and decides if a key frame is needed). Natural key frames often occur when an image changes completely, for example, when switching from one camera to another.

Decoding is also handled by the codec. Thus, when a video stream is broadcast to a particular video device, the device uses the codec to decode and play the video stream.

As indicated previously, switching from a first digital video input stream to a second digital video input stream, must be done on a “key frame” of the second video stream since only a key frame contains all image data of an image; and according to an embodiment of the present invention, a key frame is provided that is available on demand so that switching can be accomplished whenever desired.

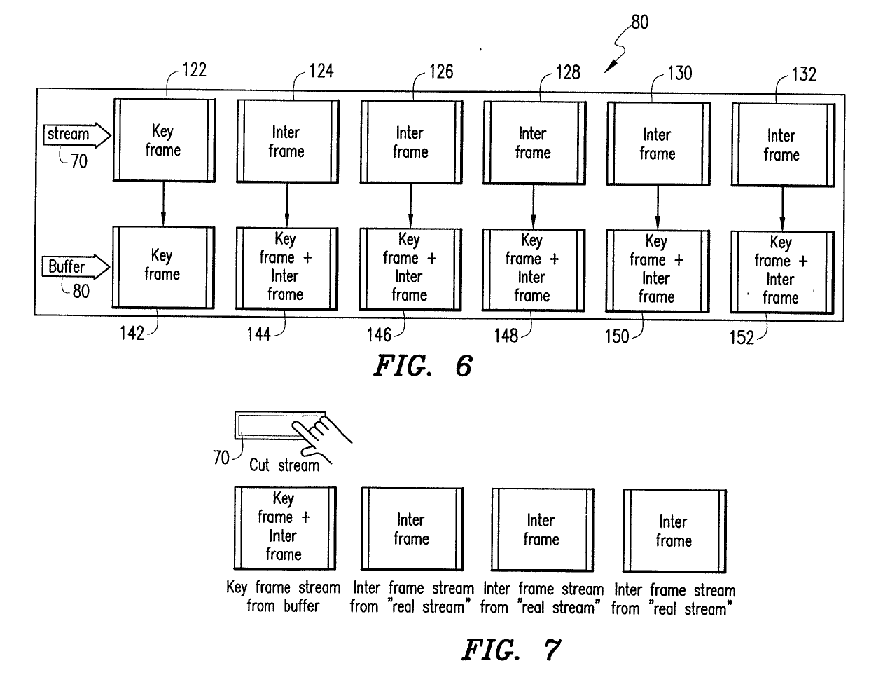

Referring back to FIG. 3, the stream tool server 62 includes a plurality of buffers 80, 82 and 84 for temporarily storing each of the video input streams from video sources 70, 72 and 74, respectively. The operation of the buffers can best be understood with reference to FIG. 6 which schematically illustrates buffer 80 and its associated incoming video stream from video source 70. As shown, the incoming stream comprises a key frame 122 and a plurality of inter frames 124, 126, 128, 130 and 132. The data from the key frame 122 is buffered in buffer location 142. Buffer locations 144, 146, 148, 150 and 152 each store the key frame data from key frame 122 and, in addition, store the inter frame data from inter frames, 126, 128, 130 and 132, respectively. Accordingly, each buffer location contains all the data of a particular image frame (either the key frame data by itself or the data of the most recent key frame super-imposed on or combined with all changes to the key frame). By using the buffer, switching from one video stream to another video stream can be accomplished at any time rather than only at a key frame of the actual incoming video stream. It should also be noted, that with the present invention, key frame data is super-imposed on inter frame data on a bit level and without decoding the streams. Accordingly, with the present invention, switching can be accomplished without any loss in the quality of the data.

In particular, as schematically illustrated in FIG. 7, when an operator switches to the video stream from source 70 from another input stream, the first frame will be from the buffer 80 and all subsequent frames will be from the actual incoming video stream from source 70. Because each buffered frame contains the most recent key frame and any changes, switching can be made at any time and it is not necessary to wait for the next key frame.

As an example, assume that there are four video input streams and one is to be broadcast to an audience. The other three are buffered and updated in real time. The first key frame from the “waiting” video streams is taken, and every bit that is coming in the streams is compared with the one in the buffered frame. If it is the same, (not changed), it is discarded. If it differs from the one in the buffered frame, the old bit is replaced with the new bit. Accordingly, there is always an updated frame ready for switching. At the moment of a switch, the buffered frame is caused to be the first frame of the switched video stream, and the remaining frames are from the actual incoming video stream.

Referring back to FIG. 3, when a particular input stream has been selected via the stream selector 78, the selected stream must be processed for broadcast by output server 64. Output server 64 includes a plurality of transcoders, e.g., transcoders 86, 88 and 90, which recode the selected video stream into desired formats for broadcast. An important aspect of the present invention is that a video stream can be broadcast over any medium including via a traditional TV network or over the Internet, and can be broadcast to any desired platform or device. The transcoders 86, 88 and 90 convert the selected video stream to the appropriate format for broadcast. For example, in FIG. 3, transcoders 86, 88 and 90 convert the selected video stream into formats for broadcast to a WinMedia stream server, a 3G stream server and a digital TV stream server.

Switching of input streams transmitted over the Internet necessitates that the streams be synchronized with one another. Although this is not needed for traditional video streaming, synchronization is important when switching between IP-streams. The present invention also provides a procedure for ensuring synchronization between video input streams before effecting switching of the streams.

Initially, it should be recognized that digital video is composed of compressed and non-compressed images, with spatial interrogation. Accordingly, even if all the data for one frame is available, a decoder may not be able to view the picture. This is not a problem in a normal decoder because the frame data comes in a well-behaved stream. When introducing the concept of digital video mixing, however, as will occur when switching from one video stream to another, the mixed video stream must be remixed into a well-behaved stream for the decoder.

In order to switch between video streams originating from different sources, two fundamental concepts must be considered: sequence number and time stamp.

The sequence number increments by one for each RTP (Real Time Protocol) packet sent, and may be used by a receiver to detect packet loss and to restore packet sequence. The initial value of the sequence number is random to make attacks on the encryption more difficult.

The time stamp is to identify elapsed time between a sender and a receiver to keep track of interference. For a particular stream, the time stamp value will be the same for all packets within the same stream. The time stamp value reflects the sampling instant of the first octet in the RTP data packet. The sampling instant must be derived from a clock that increments monotonically and linearly in time to allow synchronization and jitter calculations. The resolution of the clock must be sufficient to achieve the desired synchronization accuracy and to measure packet arrival jitter (one tick per video frame is usually not sufficient). The clock frequency is dependent on the format of data carried as payload and is specified statically in the profile or payload format specification that defines the format, or it may be specified dynamically for payload formats defined through non-RTP means. If RTP packets are generated periodically, the nominal sampling instant as determined from the sampling clock is to be used, not a reading of the system clock. For example, for fixed-rate audio, the time stamp clock would likely increment by one for each sampling period. If an audio application reads blocks covering 160 sampling periods from the input device, the timestamp would be increased by 160 for each such block, regardless of whether the block is transmitted in a packet or dropped as silent.

The initial value of the timestamp is also random. Several consecutive RTP packets may have equal timestamps if they are logically generated at once, e.g., belong to the same video frame. Consecutive RTP packets may contain timestamps that are not monotonic if the data is not transmitted in the order it was sampled, as in the case of MPEG-interpolated video frames. (The sequence numbers of the packets as transmitted will still be monotonic.)

FIG. 8 is a block diagram that schematically illustrates sequence numbering and timestamp synchronization for RTP streams. As shown, two different streams 200 and 210, each having a different sequence numbering and timestamp are synchronized and then re-calculated as shown at 215 using a synchronization module 220 in the stream tool server 62 to provide a single video output stream 225 at the output of the switch 76. This synchronization permits a an IP-level switch between two different video input streams to be accomplished without the end user (the device that receives the broadcast) receiving packets in the wrong order and throwing them away.

The concept of digital video mixing should also be considered in connection with the present invention. In digital video, two types of frames are present, full frames and differential frames. The full frames are independent of other frames and can be viewed without interaction with other frames. Differential frames use information in adjacent frames, either in the forward or backward direction, and add changes to create viewable frames.

When creating professional video, several video streams must be cut together to form a number of scenes. A video mixer, traditionally analog, is used to perform this task. When mixing digital video, however, various problems occur. Since cameras, VCRs or other equipment providing compressed digital video feeds the mixer, it has little or no influence when full frames are present in the video clip. If a full frame does not exist at the time of the cut, however, a frame must be created or a problem will occur.

The present invention constructs a new full frame and then renumbers the frames in order to make the cut transparent to the decoder.

Yet another matter that should be considered in connection with the present invention is that of “scaling”. The concept of scaling is based on the fact that in a radio network fluctuations appear due to the mechanics of the radio network and the signal bearer.

For example, in a GPRS network users are given “time slots” each of which is, in theory, capable of supplying a 12K bit packet bearer. Depending on the telephone capacity, a user can get a certain amount of timeslots. The number of time slots a user is given is dependent on mainly two factors, the amount of load in the cell, i.e., how many clients are in the cell, and the distance to the base station.

With this in mind, fluctuations occur in basically two cases: one is when x amount of clients move into a cell, and, in order to make room for these new clients, the network decreases the number of time slots already given to “existing” clients in the cell. The other is when the client moves away from the base station or if the signal is blocked, resulting in a decrease in signal strength, which in turn results in decreased time slots since the signal isn't strong enough to uphold all the time slots.

The mechanism on a 3G network is similar as for a GPRS network, but the capacity of the cell is not “measured” by the number of available time slots but instead by the available amount of bandwidth supplied by the base station. A 3G network will also react in the exact same way as a GPRS network when moving away from a base station or if there is an interference of the signal, i.e., when the signal strength decreases, the available bit rate follows.

The major differences between IP (packet)-based networks like the Internet and a Radio based IP-network like GPRS or 3G is that on the Internet the client is connected to the same access point but in a Radio network the clients move around and therefore are being “handed over” to different access points.

In general, fluctuation is an issue in very Radio Based Network, and as subscribers keep increasing, the necessity of handling fluctuations becomes more and more important.

The present invention enables switching between different video streams that have the same content but that are prepared for different bit rates. If, for example, a user is watching a news clip from CNN, the user doesn't want the news clip to be aborted by starting the stream all over again in order to get a lower bit rate version of it. It is possible that the conditions in a cell might change 5 times or more during just a one minute clip, and it would be unacceptable from a user perspective to have to start all over again every time the conditions change.

With the present invention, the user will have a “seamless” experience, i.e., the stream will continue without the need for the user to interact. The entire clip will play through, and the servers will adapt the stream by switching between the different encoded files, i.e., streams having the same content but encoded at different bit rates. This will be transparent for the user because the streams will be perceived as the same stream. The user will see the CNN clip, even though it might get “blurrier” (a lower bit rate gives a lower resolution) from time to time. The clip will, however, not stop and it will not have to be started from the beginning.

With the present invention, real time switching of live material from among a plurality of different video sources as well as of pre-recorded materials from various sources can be easily accomplished. Video streams from the sources can be transmitted via the Internet or by other means. According to one embodiment of the invention, for example, a live broadcast can be transmitted to the master controller via the Internet using a mobile telephone. In particular, a video signal is transmitted from a conventional camera to a mobile telephone having an embedded broadcaster to encode the signal. The telephone, in turn, relays the signal to an operator network from which the signal is streamed over the Internet. Thus, according to this embodiment of the invention, any one or more of the sources 70, 72 and 74 in FIG. 3 can comprise a mobile telephone.

With the present invention also, streaming video can be broadcast in any desired format, including fixed or wireless and analog or digital, to any receiving device including a PC, a digital or analog TV, a radio receiver, a mobile phone or another handheld device. The apparatus can broadcast live, recorded or buffered feeds via the same technique.

According to a further embodiment of the invention, the master controller of the present invention can function as a pre-vision mixer apparatus in a traditional television production system. For example, video input steams that come in over the Internet or a disk stored feed can be pre-mixed before the stream goes into the vision mixer as a single feed. At the output side of the vision mixer, a master controller can take the output feed from the vision mixer and transcode it to any desired format.

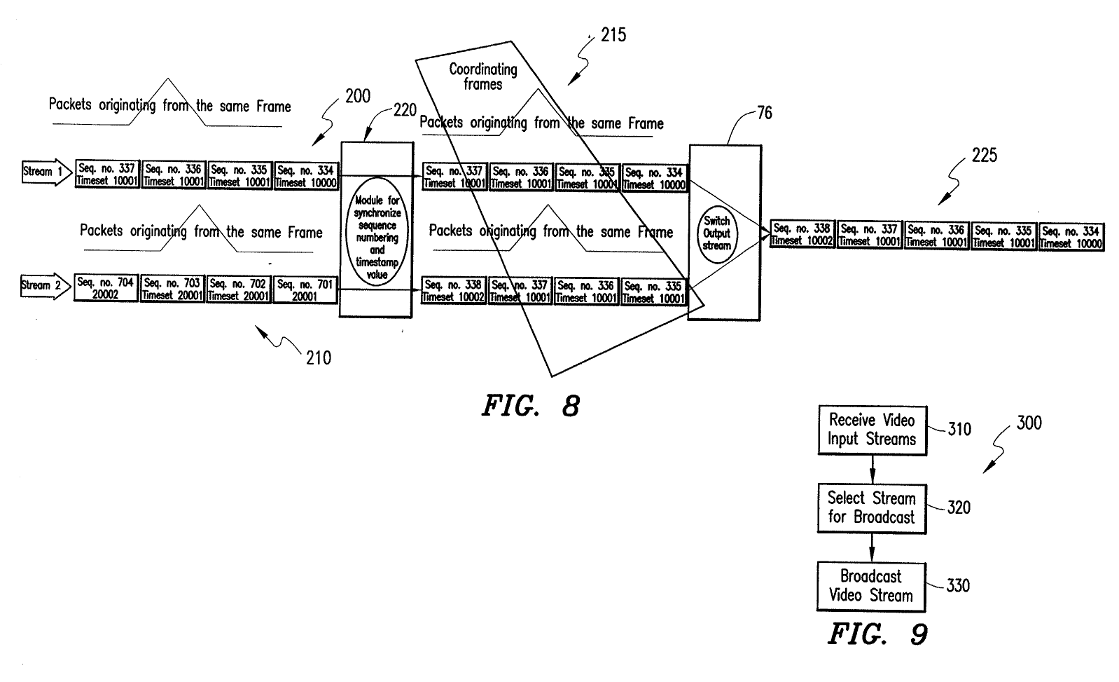

FIG. 9 is a flow chart that illustrates a method for broadcasting streaming video according to an embodiment of the present invention. The method is generally designated by reference number 300, and begins with the step of receiving a plurality of video input streams that have been transmitted via an IP-based network (step 310). One of the plurality of video input streams is then selected for broadcast as a video output stream (step 320), and the video output stream is then broadcast (step 330) via any desired broadcasting medium.

While what has been described constitute presently preferred embodiments of the invention, it should be understood that the invention can be varied in numerous ways without departing from the spirit thereof Accordingly, it should be understood that the invention should be limited only insofar as is required by the scope of the following claims.

1. A method for broadcasting streaming video comprising:
receiving a plurality of video input streams, each of said plurality of video input streams being transmitted via an IP-based network;
selecting one of said plurality of video input streams for broadcast as a video output stream; and
broadcasting said video output stream.

2. The method according to claim 1, wherein said selecting step comprises selectively switching among said plurality of video input streams.

3. The method according to claim 2, wherein at least some of said plurality of video input streams comprise live video input streams, and wherein said step of selectively switching among said plurality of video input streams is performed in real-time.

4. The method according to claim 1, wherein said step of selectively switching among said plurality of video input streams includes switching from a first video input stream to a second video input stream at a key frame of said second video input stream.

5. The method according to claim 4, wherein said key frame comprises a key frame that is created and stored in a buffer.

6. The method according to claim 5, wherein said created key frame that is stored in a buffer comprises a frame in which key frame data is super-imposed on inter frame data which contain data reflecting changes made in an image since a last key frame so that the created key frame contains all data of a particular image without any loss in quality.

7. The method according to claim 6, wherein said step of switching from a first video input stream to a second video input stream comprises switching by using a first frame of said second video input stream from said buffer and subsequent frames of said second video input stream from an actual incoming second video input stream.

8. The method according to claim 4, wherein said first video input stream and said second video input stream comprise video streams created for different bit rates.

9. The method according to claim 8, wherein said first video input stream and said second video input stream are based on the same content.

10. The method according to claim 1, wherein said broadcasting step comprises broadcasting said video output stream over an IP-based network.

11. The method according to claim 1, wherein said broadcasting step comprises simultaneously broadcasting in different formats for receipt by different receiving devices.

12. An controller for broadcasting streaming video comprising:
a receiver for receiving a plurality of video input streams transmitted thereto via an IP-based network;
a selector for selecting one of the plurality of video input streams to be broadcast;
a switch for switching among said plurality of video input streams for providing the selected video input stream as a video output stream; and
a broadcaster for broadcasting the video output stream.

13. The controller according to claim 12, wherein said switch is operable for switching among said plurality of video input streams in real-time.

14. The controller according to claim 13, wherein said broadcaster broadcasts said video output stream over an IP-based network.

15. The controller according to claim 13, wherein said broadcaster simultaneously broadcasts in different formats for receipt by different receiving devices.
